(19) United States
(12) Patent Application Publication
(10) Pub. No.: US 2016/0171529 A1
(43) Pub. Date: Jun. 16, 2016

(54) PROMOTION COMPLIANCE SYSTEMS AND METHODS

(71) Applicant: BrandVerity Inc., Seattle, WA (US)

(72) Inventors: Andrew SKALET, Seattle, WA (US); Hyung-joon KIM, Kirkland, WA (US); David NAFFZIGER, Seattle, WA (US); Alec DEASON, Seattle, WA (US); Christopher WERNER, Seattle, WA (US); Daniel CHEN, Bellevue, WA (US)

(21) Appl. No.: 14/567,815

(22) Filed: Dec. 11, 2014

(51) Int. Cl. G06Q 30/02; G06Q 30/00

(52) U.S. Cl. CPC G06Q 30/0248; G06Q 30/018

(57) ABSTRACT

A page may be monitored for compliance with a promotion regulation and/or policy by obtaining a promotion descriptor comprising a sequence of tokens corresponding to particular promotional content. Once a content page displaying several promotions is identified, a document-object-model is generated. Using the sequence of tokens, a selected content node of the document-object-model is selected as containing several child content nodes that collectively match the promotion descriptor and therefore correspond to the particular promotional content as distinguished from several other displayed promotions displayed on the page. A record is stored to associate the selected content node with the promotion descriptor. The selected content node is provided for display to a compliance monitor along with a compliance-status control for assigning a compliance status to the selected content node with respect to the particular promotional content and a promotion regulation.

### FIELD

This disclosure is directed to the field of software, and more particularly, to monitoring a page for compliance with a promotion regulation.

### BACKGROUND

In the United States, the federal government regulates advertising through the Federal Trade Commission (“FTC”). Additionally, private parties have various causes of action related to false advertising and/or unfair competition through various federal statutes, most significantly the Lanham Act.

Similarly, each state has its own unfair competition laws to prohibit false and misleading advertising. In recent years, several state attorneys general have used such laws to investigate and/or sue various for-profit colleges for (among other things) deceptive marketing practices, such as misrepresenting job placement rates.

In addition to the general false advertising and unfair competition regulations mentioned above, certain products and/or services are subject to industry-specific regulations that impose certain requirements and restrictions on advertising or promotional material.

For example, the Truth in Lending Act of 1968, as well as the Credit Card Accountability Responsibility and Disclosure Act of 2009 and other similar Acts, regulate (among other things) advertising related to consumer credit products, such as credit cards.

Thus, entities that provide goods and services have an interest in monitoring and controlling the content of marketing materials that promote those goods and services. However, it can be difficult for a goods/services provider to monitor all of the online advertising done on the provider's behalf, especially when affiliate marketers or other third-parties are at least partially responsible for drafting and/or placing promotional content.

In many cases, a human compliance monitor may be responsible for reviewing thousands of pages of promotional content, spread across hundreds or thousands of different sites, on a recurring basis. It has been difficult to automate this process in part because many sites display multiple promotions for multiple products or services on the same page. For example, many credit-card comparison websites offer numerous pages, each of which displays several promotional offers from several competing credit-card providers.

### BRIEF DESCRIPTION OF THE DRAWINGS

FIG. 1 illustrates a simplified promotion-compliance system in which promotion-monitoring server, service-provider device, promoter device, and search engine are connected to network.

FIGS. 2-3 illustrate an exemplary series of communications between promotion-monitoring server, promoter device, service-provider device, and search engine in accordance with one embodiment.

FIG. 4 illustrates a monitoring routine for monitoring a page for compliance with a promotion regulation, such as may be performed by a promotion-monitoring server in accordance with one embodiment.

FIG. 5 illustrates a descriptor subroutine for obtaining a promotion descriptor based on a given set of data describing a particular promotion, such as may be performed by a promotion-monitoring server in accordance with one embodiment.

FIG. 6 illustrates a content-node-selection subroutine for selecting a content node in a given document-object-model based on a given promotion descriptor, such as may be performed by a promotion-monitoring server in accordance with one embodiment.

FIG. 7 illustrates a DOM-traverse subroutine for traversing a given document-object-model to identify a content node whose children collectively match several given token sub-patterns derived from a given promotion descriptor, such as may be performed by a promotion-monitoring server in accordance with one embodiment.

FIG. 8 illustrates an exemplary content page user-interface showing a simplified browser-rendering of the exemplary renderable data shown in Appendices A-C and discussed herein.

FIG. 9 illustrates several components of an exemplary promotion-monitoring server in accordance with one embodiment.

### DESCRIPTION

For explanatory purposes in the description that follows, a credit-card provider is referred to as an example of an entity that may wish to monitor third-party promotional content. However, in other embodiments, similar promotion-monitoring systems and methods may be employed by providers of other types of goods and/or services.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

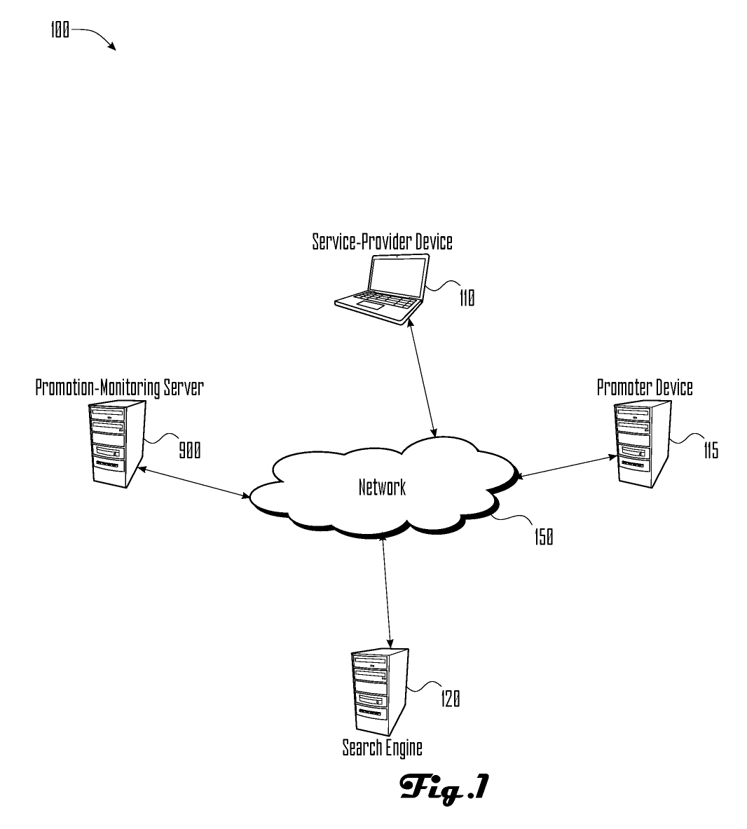

FIG. 1 illustrates a simplified promotion-compliance system in which promotion-monitoring server 900, service-provider device 110, promoter device 115, and search engine 120 are connected to network 150.

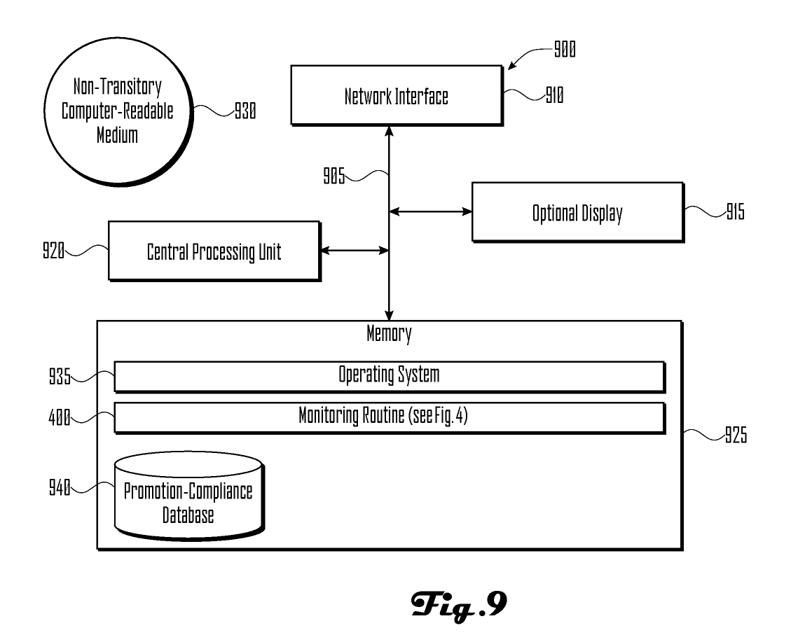

Promotion-monitoring server 900 (see FIG. 9, discussed below) represents a provider of promotion-compliance services, such as described more fully below.

In various embodiments, network 150 may include the Internet, a local area network (“LAN”), a wide area network (“WAN”), and/or other data network.

In various embodiments, service-provider device 110 may include desktop PCs, mobile phones, laptops, tablets, wearable computers, or other computing devices that are capable of connecting to network 150 and communicating with promotion-monitoring server 900, such as described herein.

In various embodiments, promoter device 115 may include desktop PCs, mobile phones, laptops, tablets, wearable computers, or other computing devices that are capable of connecting to network 150 and providing promotional content pages, such as described herein.

In various embodiments, search engine 120 may include desktop PCs, mobile phones, laptops, tablets, wearable computers, or other computing devices that are capable of connecting to network 150 and providing search-engine services, such as described herein.

In various embodiments, additional infrastructure (e.g., cell sites, routers, gateways, firewalls, and the like), as well as additional devices may be present. Further, in some embodiments, the functions described as being provided by some or all of promotion-monitoring server 900, promoter device 115, and search engine 120 may be implemented via various combinations of physical and/or logical devices.

However, it is not necessary to show such infrastructure and implementation details in FIG. 1 in order to describe an illustrative embodiment.

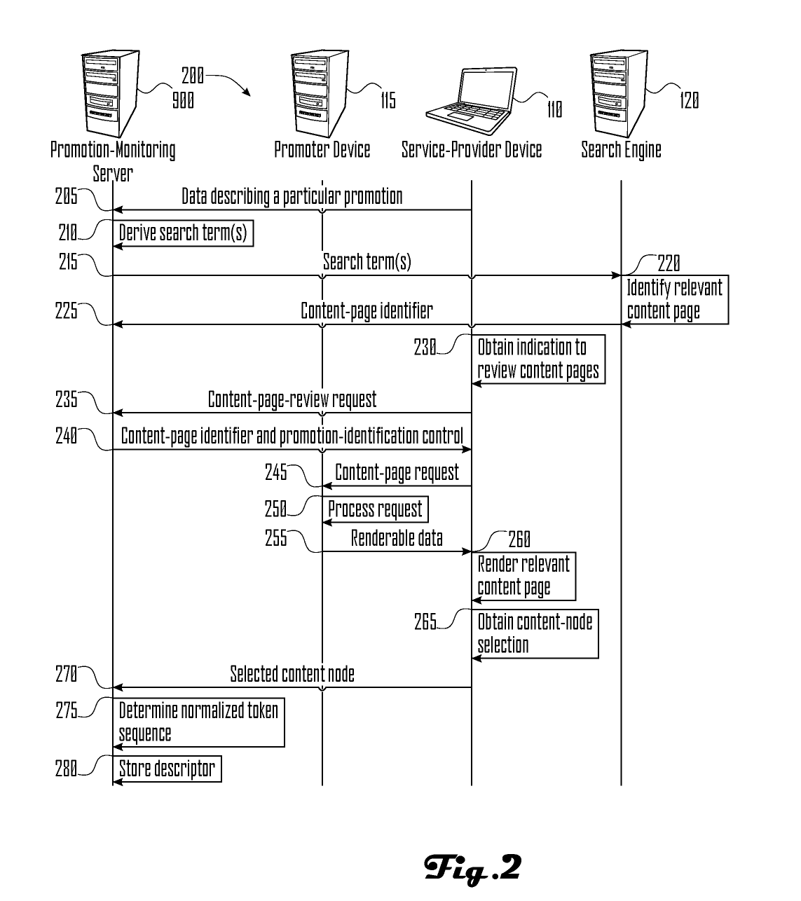

FIG. 2 illustrates an exemplary series of communications between promotion-monitoring server 900, promoter device 115, service-provider device 110, and search engine 120 in accordance with one embodiment. The communications shown in FIG. 2 do not encompass every combination of possibilities in which the systems and methods provided herein may be employed. Rather, the illustrated communications merely provide an overview of one simplified example scenario. Additional variations and alternatives are described more fully in the Figures and description that follow.

Beginning the illustrated sequence of communications, service-provider device 110 sends to promotion-monitoring server 900 data describing a particular promotion 205 related to a particular product and/or service. Typically, promotion-monitoring server 900 provides a user interface and/or an application programming interface (“API”) by which service-provider device 110 may provide information related to a promotion that service-provider device 110 wishes to monitor.

In many cases, at this stage, service-provider device 110 may provide only a limited set of data, such as a few term's associated with the brand(s) being promoted (e.g., “VISA® Unobtainium”, “Credit Three Bank®”, and the like), and perhaps a few term's associated with a particular promotion (e.g., “1% back on all gas purchases”, “gas rewards”). In some cases, service-provider device 110 may also provide a list of one or more third-party domains and/or sites that may promote the goods and/or services at issue.

However, the information provided at this point is generally fairly minimal—not sufficient to serve as the basis for an effective promotion-monitoring service without further processing. Consequently, promotion-monitoring server 900 derives 210 one more more search terms, based at least in part on the provided data describing particular promotional content, that may be likely to identify content pages displaying the promotion for the particular goods and/or services.

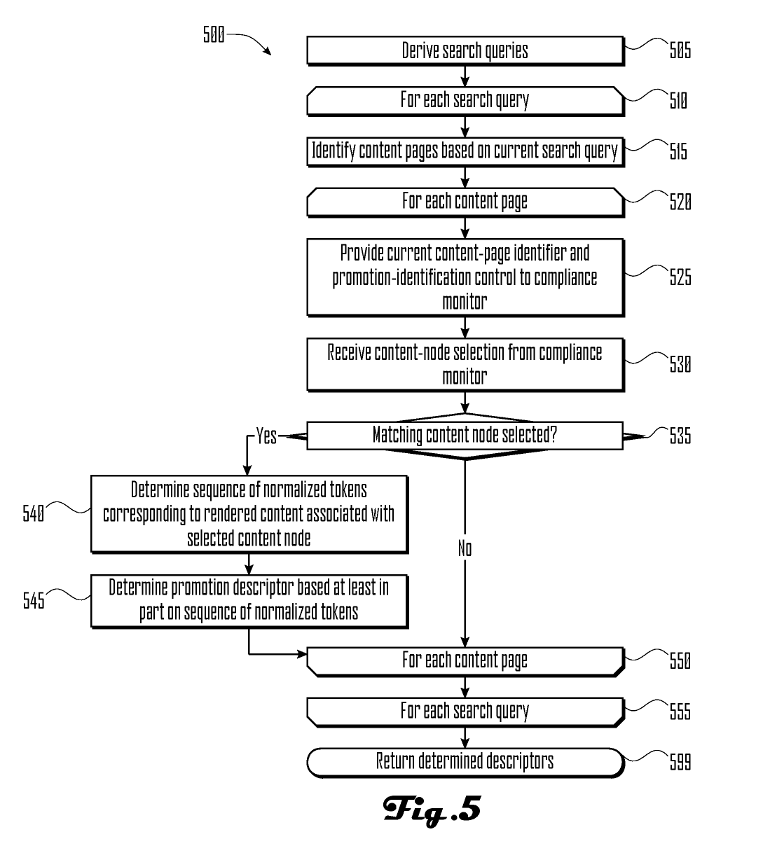

One example of such a search-term-derivation process is shown in descriptor subroutine 500 (see FIG. 5, discussed below). In this simplified example, promotion-monitoring server 900 may combine some or all of the provided brand terms with some or all of the promotional terms to obtain sets of search terms such as: “VISA® Unobtainium gas rewards”, “VISA® Unobtainium 1% back gas”, and the like.

Promotion-monitoring server 900 sends the one or more search terms 215 to search engine 120, which identifies 220 at least one relevant content page based thereon and sends to promotion-monitoring server 900 at least one content-page identifier 225, typically a uniform resource locator (“URL”) or a uniform resource identifier (“URI”), identifying the relevant content page. In the illustrated example, the content-page identifier 225 identifies a content page provided by promoter device 115.

At some point thereafter, service-provider device 110 obtains 230 (generally from a compliance monitor operating service-provider device 110) an indication to review one or more content pages.

In response to receiving the indication, service-provider device 110 sends to promotion-monitoring server 900 a request 235 to review one or more content pages that promotion-monitoring server 900 has identified as being likely to include the particular promotion indicated above.

In response, promotion-monitoring server 900 sends to service-provider device 110 one or more content-page identifiers 240 and a promotion-identification control by which a compliance monitor can review the identified content page(s). In one embodiment, the promotion-identification control may be part of a browser plugin.

When processing the content page provided by promoter device 115, service-provider device 110 sends to promoter device 115 a request 245 for the relevant content page previously identified by search engine 120 in response to search terms derived and provided by promotion-monitoring server 900.

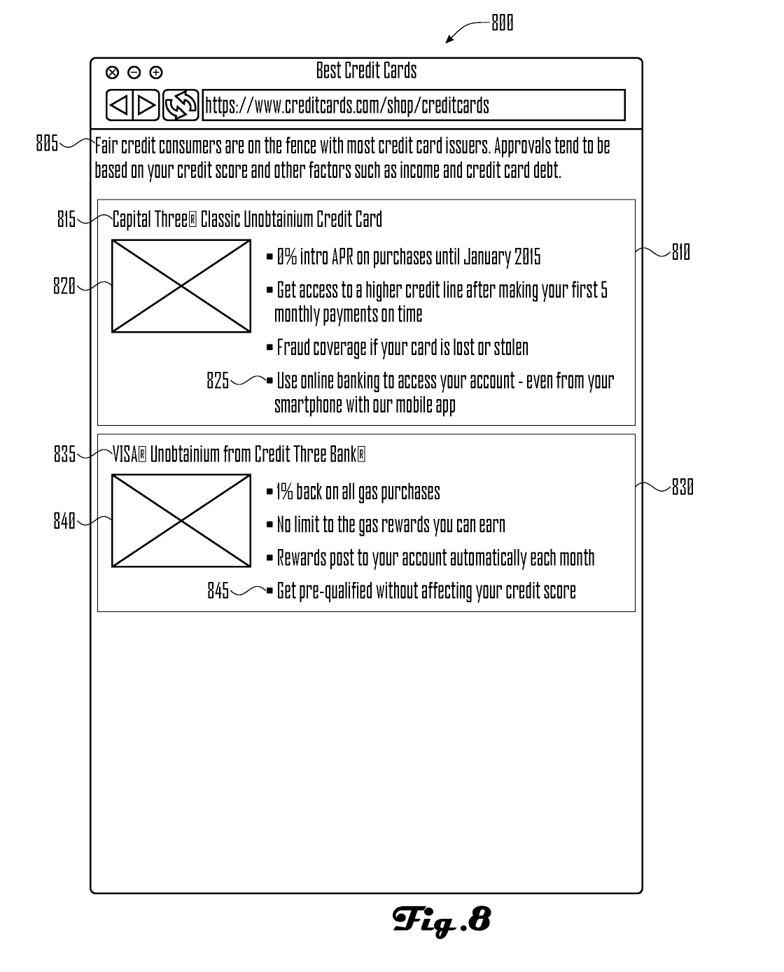

Promoter device 115 processes 250 the request and sends renderable page-source data 255 to service-provider device 110, which renders the relevant content page. For example, in one embodiment, the render 260 may include data similar to that shown in Appendix A (below), and the rendered content page may resemble content page user-interface 800 (see FIG. 8, discussed below).

Using the promotion-identification control, the compliance monitor operating service-provider device 110 selects 265 a content node that corresponds to the particular promotion. For example, in one embodiment, service-provider device 110 may obtain an indication selecting renderable data corresponding to example promotion 830 (see FIG. 8, discussed below).

Having obtained a selection, service-provider device 110 sends to promotion-monitoring server 900 renderable data corresponding to the selected content node 270. For example, in one embodiment, service-provider device 110 may send renderable data including renderable data similar to some or all of the following.

```
<h4>VISA® Unobtainium from Credit Three Bank®</h4>
<div>
  <div>
    <img src=“./cccreditthreebank01_small.png” width=“125” height=
    “78”>
    </div>
  </div>
<div>
  <ul>
    <li>1% back on all gas purchases</li>
    <li>No limit to the gas rewards you can earn</li>
    <li>Rewards post to your account automatically each month</li>
    <li>Get pre-qualified without affecting your credit score</li>
    </ul>
  </div>
```

Promotion-monitoring server 900 determines 275 a normalized token sequence based on the renderable data and stores the descriptor (e.g. in promotion-compliance database 940). One example of such a token-determination process is shown in descriptor subroutine 500 (see FIG. 5, discussed below). In one embodiment, promotion-monitoring server 900 may determine a normalized token sequence including tokens similar to some or all of the following.
visa® unobtainium credit three bank® cccreditthreebank01small 1% back all gas purchases no limit gas rewards you can earn rewards post account automatically each month get pre qualified without affecting credit score

In some embodiments, the descriptor may also include a list of one or more brand terms, such as VISA® Unobtainium and/or Credit Three Bank®, and/or list of one or more third-party domains and/or sites that may promote the goods and/or services at issue.

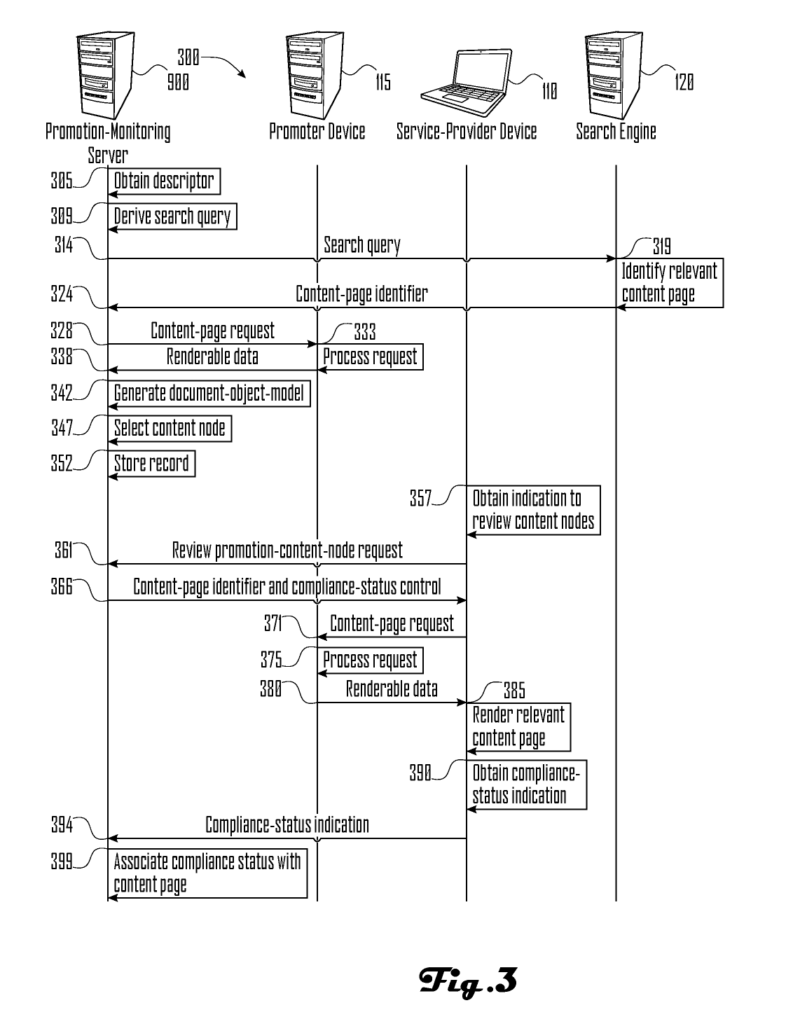

FIG. 3 illustrates an exemplary series of communications between promotion-monitoring server 900, promoter device 115, service-provider device 110, and search engine 120 in accordance with one embodiment. The communications shown in FIG. 3 do not encompass every combination of possibilities in which the systems and methods provided herein may be employed. Rather, the illustrated communications merely provide an overview of one simplified example scenario. Additional variations and alternatives are described more fully in the Figures and description that follow.

Beginning the illustrated sequence of communications, promotion-monitoring server 900 obtains 305 (e.g. from promotion-compliance database 940) a previously-determined descriptor describing a particular promotion for one or more particular goods and/or services.

In some embodiments, the descriptor may also include one or more term's associated with the brand(s) being promoted. For example, in one embodiment, the descriptor may include brand terms such as VISA® Unobtainium and/or Credit Three Bank®.

Promotion-monitoring server 900 derives 309 several search queries based at least in part on the obtained descriptor. In various embodiments, various techniques and/or combinations thereof may be employed to derive search terms from a descriptor.

For example, in one embodiment, promotion-monitoring server 900 may generate a series of N-grams (e.g., 6-grams) based on a sequence of normalized tokens and combine each N-gram with one of more brand terms. For example, given the brand terms mentioned above and a sequence of normalized tokens such as described above, promotion-monitoring server 900 may derive several search queries such as some or all of the following.
VISA® Unobtainium from Credit Three Bank® VISA® Unobtainium
VISA® Unobtainium from Credit Three Bank® Credit Three Bank®
Unobtainium from Credit Three Bank® 1% VISA® Unobtainium
Unobtainium from Credit Three Bank® 1% Credit Three Bank®
from Credit Three Bank® 1% back VISA® Unobtainium
from Credit Three Bank® 1% back Credit Three Bank®
Credit Three Bank® 1% back on VISA® Unobtainium
Credit Three Bank® 1% back on Credit Three Bank®
Three Bank® 1% back on all VISA® Unobtainium
Three Bank® 1% back on all Credit Three Bank®
Bank® 1% back on all gas VISA® Unobtainium
Bank® 1% back on all gas Credit Three Bank®
1% back on all gas purchases VISA® Unobtainium
1% back on all gas purchases Credit Three Bank®
back on all gas purchases No VISA® Unobtainium
back on all gas purchases No Credit Three Bank®
on all gas purchases No limit VISA® Unobtainium

[symbol]

In other embodiments, promotion-monitoring server 900 may also or instead generate search queries using other techniques, such as by combining brand terms with some or all of the most and/or least common tokens in the sequence of normalized tokens. Search queries derived using such techniques may be suitable for performing searches of websites using a general-purpose search engine.

In some embodiments, if the descriptor includes a list of one or more third-party domains and/or sites that may promote the goods and/or services at issue, promotion-monitoring server 900 may also or instead generate site-specific search queries for searching each of the individual third-party domains and/or sites. For example, in one embodiment, promotion-monitoring server 900 may generate queries to search a given site using brand terms (e.g., “site:domainone.com VISA® Unobtainium”, “site:domainone.com Credit Three Bank®”, site:domaintwo.com VISA® Unobtainium“, and the like).

Having derived one or more search queries using techniques such as those described above, promotion-monitoring server 900 sends to search engine 120 a search query 314. In some embodiments, promotion-monitoring server 900 may derive dozens (or more) of search queries for a given descriptor. In such cases, promotion-monitoring server 900 may distribute those searches across a period of time (e.g., a day), periodically performing a subset of the queries. The illustrated scenario is directed to following the results of performing a single one of the many queries that promotion-monitoring server 900 may have derived.

In response to receiving the search query from promotion-monitoring server 900, search engine 120 identifies 319 at least one relevant content page that is likely to include promotional content corresponding to the particular promotion for the particular goods and/or services.

Search engine 120 sends to promotion-monitoring server 900 a content page-identifier 324, typically as one of several search results. Although the illustrated scenario describes how a single result page is processed, in some embodiments, promotion-monitoring server 900 may obtain a list of several dozen of the most relevant content pages for subsequent processing similar to that described below. In many embodiments, the actions described below may be scheduled as part of a recurring crawl process that may periodically visit and process the various result pages.

Promotion-monitoring server 900 sends to promoter device 115 a request 328 for the identified content page. Promoter device 115 processes 333 the request and sends renderable data 338 to promotion-monitoring server 900. In one embodiment, renderable data 338 may include data similar to that shown in Appendix A (below).

Promotion-monitoring server 900 generates 342 a document-object-model based on the received renderable data. For example, in one embodiment, promotion-monitoring server 900 may generate a document-object-model data object including data similar to some or all of that shown in Appendix B.

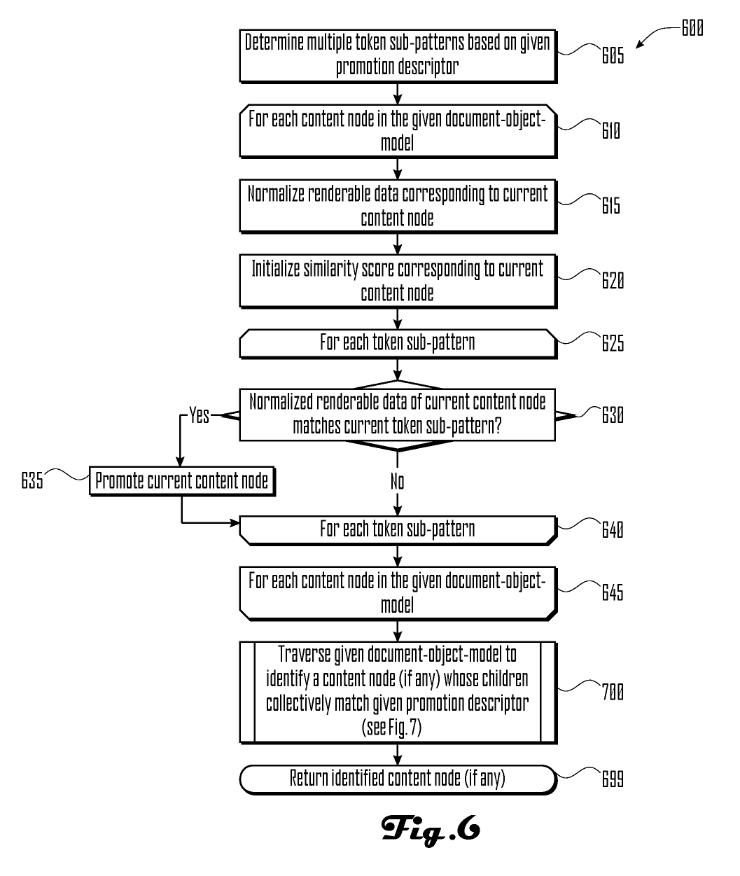

At this point, promotion-monitoring server 900 has a goal to identify the particular promotion from among the various pieces of content on the page. To that end, promotion-monitoring server 900 uses the descriptor to select 347 a content node that corresponds to the particular promotion for one or more particular goods and/or services. One example of such a node-selection process is shown in content-node-selection subroutine 600 (see FIG. 6, discussed below).

Having selected a content node that corresponds to the particular promotion, promotion-monitoring server 900 stores 352 (e.g. in promotion-compliance database 940) a record associating the selected content node and the promotion descriptor.

At some point thereafter, service-provider device 110 obtains 357 (generally from a compliance monitor operating service-provider device 110) an indication to review content nodes on one or more content pages that promotion-monitoring server 900 has identified as including the particular promotion indicated above.

In response to receiving the indication, service-provider device 110 sends to promotion-monitoring server 900 a request 361 to review content nodes. In response, promotion-monitoring server 900 sends to service-provider device 110 one or more content-page identifiers 366 and a compliance-status control by which a compliance monitor can review the identified content nodes and indicate whether it complies with one or more pertinent regulations and/or policies. In one embodiment, the compliance-status control may be part of a browser plugin.

When processing the content page provided by promoter device 115, service-provider device 110 sends to promoter device 115 a request 371 for the relevant content page previously identified by search engine 120 in response to search terms derived and provided by promotion-monitoring server 900.

Promoter device 115 processes 375 the request and sends renderable page-source data 380 to service-provider device 110, which renders the relevant content page. For example, in one embodiment, the render 385 may include data similar to that shown in Appendix A (below), and the rendered content page may resemble content page user-interface 800 (see FIG. 8, discussed below).

Service-provider device 110 obtains 390 a compliance-status indication via the compliance-status control and sends the compliance-status indication to promotion-monitoring server 900, which associates 399 the compliance status with content page (e.g. in promotion-compliance database 940). In some embodiments, promotion-monitoring server 900 may also add the content node to a queue for subsequent monitoring, to determine whether compliance status subsequently changes.

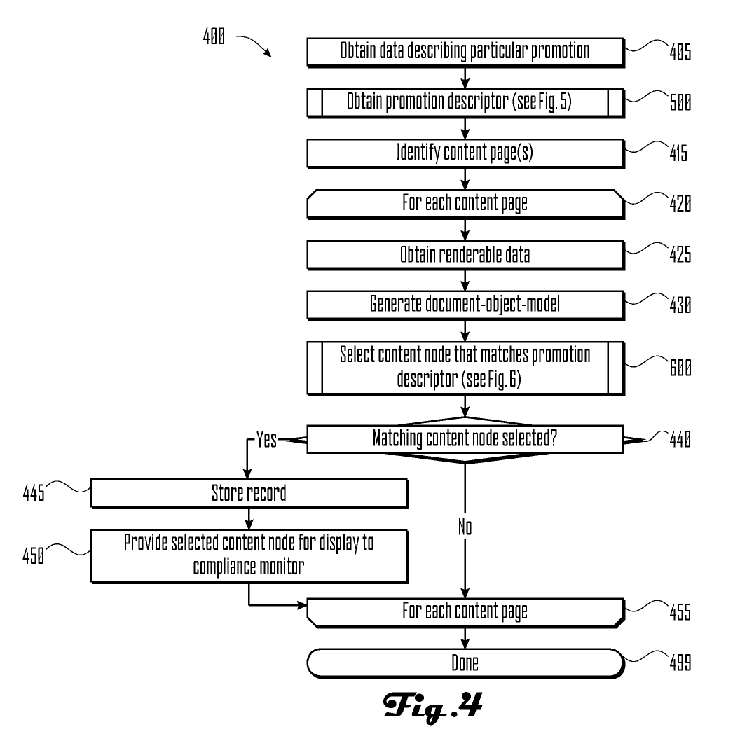

FIG. 4 illustrates a monitoring routine 400 for monitoring a page for compliance with a promotion regulation, such as may be performed by a promotion-monitoring server 900 in accordance with one embodiment.

In block 405, monitoring routine 400 obtains data describing a particular promotion related to a particular product and/or service. Typically, such data is provided by a compliance monitor or other agent of a provider of the product and/or service in question. As discussed above, in many cases, at this stage, the compliance monitor may provide only a limited set of data, such as a few terms associated with the brand(s) being promoted (e.g., “VISA® Unobtainium”, “Credit Three Bank®”, and the like), and perhaps a few terms associated with a particular promotion (e.g., “1% back on all gas purchases”, “gas rewards”). In some cases, the compliance monitor may also provide a list of one or more third-party domains and/or sites that may promote the goods and/or services at issue.

In subroutine block 500, monitoring routine 400 calls subroutine 500 (see FIG. 5, discussed below) to obtain a promotion descriptor based on the data obtained in block 405. Based at least in part on the promotion descriptor, in block 415, monitoring routine 400 identifes one or more content pages that are likely to include promotional content corresponding to the particular promotion for the particular goods and/or services.

As discussed above, in some embodiments, such content pages may be identified by querying a general-purpose web search engine using queries derived from the promotion descriptor. Briefly, a typical promotion descriptor includes a sequence of normalized tokens, one or more brand terms, and an optional list of third-party domains and/or sites.

In various embodiments, various techniques and/or combinations thereof may be employed to derive search terms from a descriptor. To briefly recap the techniques described above:
in some embodiments, monitoring routine 400 may generate a series of N-grams (e.g., 6-grams) based on a sequence of normalized tokens and combine each N-gram with one of more brand term's;
in some embodiments, monitoring routine 400 may generate search queries by combining brand term's with some or all of the most and/or least common tokens in the sequence of normalized tokens;
in some embodiments, monitoring routine 400 may generate site-specific search queries using brand terms for searching one or more individual third-party domains and/or sites.

Each query generated using such techniques may be submitted to a search engine, and URLs or other identifiers identifying the top N result pages (e.g., the top 40-60 pages) may be captured and/or queued for subsequent processing as described below. In many cases, monitoring routine 400 may derive dozens (or more) of search queries for a given descriptor. In such cases, monitoring routine 400 may distribute those searches across a period of time (e.g., a day).

Beginning in opening loop block 420, monitoring routine 400 processes each content page in turn. In block 425, monitoring routine 400 obtains renderable data corresponding to the current content page (e.g., by requesting the renderable data from a hosting server). In one embodiment, the renderable data thereby obtained may include data similar to that shown in Appendix A (below).

In block 430, monitoring routine 400 generates a document-object-model from the renderable data. For example, in one embodiment, using techniques that are well-known in the page-rendering arts, monitoring routine 400 may generate a document-object-model data object including data similar to some or all of that shown in Appendix B.

In subroutine block 600, monitoring routine 400 calls subroutine 600 (see FIG. 6, discussed below) to select from the document-object-model a content node that matches the promotion descriptor. For example, when processing a content page including renderable data similar to that shown in content page user-interface 800 (see FIG. 8, discussed below), monitoring routine 400 may select a content node corresponding to example promotion 830 as matching a descriptor describing a promotion for a gas-rewards credit card product provided by Credit Three Bank.

In decision block 440, monitoring routine 400 determines whether a matching content node was selected in subroutine block 600. If so, monitoring routine 400 proceeds to block 445; otherwise, monitoring routine 400 proceeds to ending loop block 455.

In block 445, monitoring routine 400 stores (e.g. in promotion-compliance database 940) a record associating the selected content node of the current content page and the promotion descriptor.

At some point thereafter, in block 450, monitoring routine 400 provides the selected content node for display to a compliance monitor, who may review the content of the content node to determine whether it complies with one or more pertinent regulations and/or policies. In some embodiments, the content node may be periodically monitored to determine whether its contents have changed since the last time it was reviewed by the compliance monitor.

In ending loop block 455, monitoring routine 400 iterates back to opening loop block 420 to process the next content page, if any. Once each content page has been processed, monitoring routine 400 ends in ending block 499.

FIG. 5 illustrates a descriptor subroutine 500 for obtaining a promotion descriptor based on a given set of data describing a particular promotion, such as may be performed by a promotion-monitoring server 900 in accordance with one embodiment.

As described above, in many cases, at this stage, the given set of data describing the particular promotion may include only a limited set of data, such as a few terms associated with the brand(s) being promoted (e.g., “VISA® Unobtainium”, “Credit Three Bank®”, and the like), and perhaps a few terms associated with a particular promotion (e.g., “1% back on all gas purchases”, “gas rewards”). In some cases, the given set of data describing the particular promotion may also include a list of one or more third-party domains and/or sites that may promote the goods and/or services at issue.

Generally, the given set of data describing the particular promotion is not sufficient, without further processing, to serve as the basis for an effective promotion-monitoring service.

To begin the process of deriving a descriptor, in block 505, descriptor subroutine 500 uses the given set of data describing the particular promotion to derive several search queries that may be likely to identify content pages displaying the particular promotion.

In one embodiment, descriptor subroutine 500 may concatenate or otherwise combine some or all of the provided brand terms with some or all of the promotional terms to obtain sets of search queries such as: “VISA® Unobtainium gas rewards”, “VISA® Unobtainium 1% back gas”, and the like.

Beginning in opening loop block 510, descriptor subroutine 500 processes each search query in turn. In block 515, descriptor subroutine 500 identifies one or more content pages based on current search query. As discussed above, in some embodiments, such content pages may be identified by querying a general-purpose web search engine using queries derived in block 505. In some embodiments, URLs or other identifiers identifying the top N result pages (e.g., the top 40-60 pages) may be captured and/or queued for further processing as described below.

Beginning in opening loop block 520, descriptor subroutine 500 processes each content page in turn. In many cases, the current content page may display multiple promotions, only one of which corresponds to the given set of data describing the particular promotion. For example, content page user-interface 800 (see FIG. 8, discussed below) displays two different promotions, example promotion 810 and example promotion 830. The given set of data describing the particular promotion may not include sufficient information to allow descriptor subroutine 500 to automatically select among various promotions that may be displayed.

Consequently, in block 525, descriptor subroutine 500 provides to a compliance monitor the current content-page identifier, as well as a promotion-identification control by which the compliance monitor can review the current content page and indicate zero or one portions of the page that correspond to the given set of data describing the particular promotion. In one embodiment, the promotion-identification control may be implemented as part of a browser plugin.

In block 530, descriptor subroutine 500 receives from the compliance monitor a selection indicating zero or one portions of the page that correspond to the given set of data describing the particular promotion.

In decision block 535, descriptor subroutine 500 determines whether a matching content node was selected in block 530. If so, descriptor subroutine 500 proceeds to block 540; otherwise, descriptor subroutine 500 proceeds to ending loop block 550.

In block 540, descriptor subroutine 500 determines a sequence of normalized tokens corresponding to rendered content associated with the content node selected in block 530. In various embodiments, any suitable method for normalizing the rendered content may be employed. In one embodiment, the normalization process may include steps such as converting textual content to lower case, stripping HTML and other structural and/or formatting elements, removing stop words, replacing all types of white space with the space character or other similar character, removing non-word characters except for those (e.g., [$%®]) that are likely to help identify the promotional content in question, and the like.

In one simplified example, if in block 530, descriptor subroutine 500 received a selection indicating a content node corresponding to example promotion 830 (see FIG. 8, discussed below), then in block 540, descriptor subroutine 500 may obtain and process renderable data corresponding to example promotion 830, including renderable data similar to some or all of the following.

```
<h4>VISA® Unobtainium from Credit Three Bank®</h4>
<div>
  <div>
    <img src=“./cccreditthreebank01_small.png” width=“125” height=
    “78”>
    </div>
  </div>
<div>
  <ul>
    <li>1% back on all gas purchases</li>
    <li>No limit to the gas rewards you can earn</li>
    <li>Rewards post to your account automatically each month</li>
    <li>Get pre-qualified without affecting your credit score</li>
    </ul>
  </div>
```

In one embodiment, descriptor subroutine 500 may strip HTML elements and normalize the content to obtain a sequence of normalized tokens similar to some or all of the following.
visa® unobtainium credit three bank® cccreditthreebank01small 1% back all gas purchases no limit gas rewards you can earn rewards post account automatically each month get pre qualified without affecting credit score

Note that in the above example, a token (‘cccreditthreebank01small’) has been derived from non-textual rendered content, namely image 840. Here, a normalized token has been derived from the ‘src’ attribute of the ‘img’ tag corresponding to image 840. In other embodiments, a token may be derived from an image or other non-textual rendered content by other techniques, such as computing a hash and/or fingerprint from the image data itself (as opposed to the file name, as in the example provided above).

In block 545, descriptor subroutine 500 determines a promotion descriptor based at least in part on the sequence of normalized tokens determined in block 540, as well as given set of data describing the particular promotion. For example, in one embodiment, descriptor subroutine 500 may determine a promotion descriptor including data similar to some or all of the following.
normalized tokens: “visa® unobtainium credit three bank®
cccreditthreebank01small 1% back all gas purchases no limit gas rewards you can earn rewards post account automatically each month get pre qualified without affecting credit score”
brand_terms:
   VISA® Unobtainium
   Credit Three Bank®
sites:
   domainone.com
   domaintwo.com

In ending loop block 550, descriptor subroutine 500 iterates back to opening loop block 520 to process the next content page, if any. In ending loop block 555, descriptor subroutine 500 iterates back to opening loop block 510 to process the next search query, if any. Descriptor subroutine 500 ends in ending block 599, returning to the caller the one or more promotion descriptors determined in iterations of block 545.

FIG. 6 illustrates a content-node-selection subroutine 600 for selecting a content node in a given document-object-model based on a given promotion descriptor, such as may be performed by a promotion-monitoring server 900 in accordance with one embodiment.

In one embodiment, the given promotion descriptor may include data similar to some or all of that shown above in relation to block 545, and the given document-object-model may include data similar to some or all of that shown in Appendix B.

In block 605, content-node-selection subroutine 600 determines multiple token sub-patterns based on the given promotion descriptor. In one embodiment, each individual token sub-pattern may consist of a contiguous sequence of ‘N’ words (or similar tokens) from the given promotion descriptor, where ‘N’ is an integer greater than zero. In many embodiments, ‘N’ may be an integer inclusively between 1-6.

The following examples are based on the following sequence of normalized tokens.
visa® unobtainium credit three bank® cccreditthreebank01small 1% back all gas purchases no limit gas rewards you can earn rewards post account automatically each month get pre qualified without affecting credit score

For example, when ‘N’ has a value of 3, content-node-selection subroutine 600 may determine several token sub-patterns such as the following.

/visa® unobtainium credit/
/unobtainium credit three/
/credit three bank®/
/three bank® cccreditthreebank01small/
/bank® cccreditthreebank01small 1%/
/cccreditthreebank01small 1% back/
/1% back all/
/back all gas/
/all gas purchases/
/gas purchases no/
/purchases no limit/
.
.
.

Similarly, when ‘N’ has a value of 6, content-node-selection subroutine 600 may determine several token sub-patterns such as the following.

/visa® unobtainium credit three bank® cccreditthreebank01small/
/unobtainium credit three bank® cccreditthreebank01small 1%/
/credit three bank® cccreditthreebank01small 1% back/
/three bank® cccreditthreebank01small 1% back all/
/bank® cccreditthreebank01small 1% back all gas/
/cccreditthreebank01small 1% back all gas purchases/
/1% back all gas purchases no/
/back all gas purchases no limit/
/all gas purchases no limit gas/
/gas purchases no limit gas rewards/
/purchases no limit gas rewards you/
.
.
.

In some embodiments, the several token sub-patterns may be represented by regular expressions or similar pattern-matching constructs.

In some embodiments, content-node-selection subroutine 600 may combine token sub-patterns with differing values of ‘N’. For example, in one embodiment, content-node-selection subroutine 600 may generate token sub-patterns for every integer value of ‘N’ inclusively between 1-6.

In some embodiments, content-node-selection subroutine 600 may also determine one or more token sub-patterns based on brand terms defined in the given promotion descriptor. For example, in one embodiment, content-node-selection subroutine 600 may also determine token sub-patterns similar to the following.

/VISA® Unobtainium/
/Credit Three Bank®/

Beginning in opening loop block 610, content-node-selection subroutine 600 processes each content node in the given document-object-model in turn. In block 615, content-node-selection subroutine 600 normalizes renderable data corresponding to the current content node. Typically, content-node-selection subroutine 600 uses a normalization process that is identical or very similar to that described in block 540 (see FIG. 5, discussed above). As described above, in one embodiment, the normalization process may include steps such as converting textual content to lower case, stripping HTML and other structural and/or formatting elements, removing stop words, replacing all types of white space with the space character or other similar character, removing non-word characters except for those (e.g., [$%®]) that are likely to help identify the promotional content in question, and the like.

For example, in one embodiment, when processing the document-object-model object having an id of “node_7”, content-node-selection subroutine 600 may obtain the renderable contents thereof, such as the following.

```
<h4 id=“node_8” score=“0”>
  Capital Three® Classic Unobtainium Credit Card
</h4>
<div id=“node_9” score=“0”>
  <div id=“node_10” score=“0”>
    <img src=“./cccapitalthree681_small.png” width=“125” height=“78”
id=“node_11”>
    </div>
  </div>
<div id=“node_12” score=“0”>
  <ul id=“node_13” score=“0”>
    <li id=“node_14” score=“0”>
      0% intro APR on purchases until January 2015
    </li>
    <li id=“node_15” score=“0”>
      Get access to a higher credit line after making your first 5 monthly
      payments on time
    </li>
    <li id=“node_16” score=“0”>
      Fraud coverage if your card is lost or stolen
    </li>
    <li id=“node_17” score=“0”>
      Use online banking to access your account - even from your
      smartphone with our mobile app
    </li>
    </ul>
  </div>
```

After normalization, content-node-selection subroutine 600 may obtain normalized data similar to some or all of the following.
capital three® classic unobtainium credit card cccapitalthree681_small 0% intro apr purchases january 2015 get access higher credit line making first 5 monthly payments time fraud coverage card is lost stolen use online banking access account even smartphone our mobile app

Similarly, when processing the document-object-model object having an id of “node_18”, content-node-selection subroutine 600 may obtain the renderable contents thereof, such as the following.

```
<div id=“node_19” score=“21” top_child=“node_24” delta=“0.19”
fingerprint_match=“true”>
  <h4>
    VISA® Unobtainium from Credit Three Bank®
  </h4>
  <div>
    <div>
      <img src=“./cccreditthreebank01_small.png” width=“125”
      height=“78”>
      </div>
    </div>
  <div>
    <ul>
      <li>
        1% back on all gas purchases
      </li>
      <li>
        No limit to the gas rewards you can earn
      </li>
      <li>
        Rewards post to your account automatically each month
      </li>
      <li>
        Get pre-qualified without affecting your credit score
      </li>
      </ul>
    </div>
  </div>
```

After normalization, content-node-selection subroutine 600 may obtain normalized data similar to some or all of the following.
visa® unobtainium credit three bank® cccreditthreebank01_small 1% back all gas purchases no limit gas rewards you can earn rewards post account automatically each month get pre qualified without affecting credit score

In block 620, content-node-selection subroutine 600 initializes a similarity score corresponding to the current content node. For example, in one embodiment, content-node-selection subroutine 600 may add to the current content node of the given document-object-model a “score” attribute having a value of “0”.

Beginning in opening loop block 625, content-node-selection subroutine 600 processes each token sub-pattern (determined in block 605) in turn. In decision block 630, content-node-selection subroutine 600 determines whether the normalized renderable data of the current content node (determined in block 615) matches the current token sub-pattern. If so, content-node-selection subroutine 600 proceeds to block 635; otherwise, content-node-selection subroutine 600 proceeds to ending loop block 640.

For example, in one embodiment, content-node-selection subroutine 600 may determine that the normalized data corresponding to “node_7” (as discussed above) does not match a token sub-pattern derived from the given promotion descriptor (as discussed above) by executing an instruction similar to the following.
/visa® unobtainium credit/.test(“capital three® classic unobtainium credit card cccapitalthree681_small 0% intro apr purchases january 2015 get access higher credit line making first 5 monthly payments time fraud coverage card is lost stolen use online banking access account even smartphone our mobile app”)

Similarly, in one embodiment, content-node-selection subroutine 600 may determine that the normalized data corresponding to “node_18” (as discussed above) does match a token sub-pattern derived from the given promotion descriptor (as discussed above) by executing an instruction similar to the following.
/visa® unobtainium credit/.test(“visa® unobtainium credit three bank®
cccreditthreebank01_small 1% back all gas purchases no limit gas rewards you can earn rewards post account automatically each month get pre qualified without affecting credit score”)

If in decision block 630, content-node-selection subroutine 600 determines that the current content node matches the current token sub-pattern, then in block 635, content-node-selection subroutine 600 promotes the current content node, such as by incrementing the similarity score (initialized in block 620) by a promotion value (e.g., by 1).

In some embodiments, different token sub-patterns may be associated with different promotion values. For example, in one embodiment, token sub-patterns derived from the sequence of normalized tokens of the given promotion descriptor may have a first promotion value (e.g., 1), while token sub-patterns derived from brand terms of the given promotion descriptor may have a second promotion value (e.g., 2). In other embodiments, other promotion-value schemes may be equivalently employed.

In ending loop block 640, content-node-selection subroutine 600 iterates back to opening loop block 625 to process the next token sub-pattern (determined in block 605), if any. In ending loop block 645, content-node-selection subroutine 600 iterates back to opening loop block 610 to process the next content node in the given document-object-model, if any.

In one embodiment, after each content node shown in Appendix B has been evaluated against 6 -gram token sub-patterns and brand-term token sub-patterns derived from the promotion descriptor shown above, the content nodes may have similarity scores such as the following.

node_0: 21
node_1: 21
node_2: 21
node_3: 21
node_4: 0
node_5: 0
node_6: 0
node_7: 0
node_8: 0
node_9: 0
node_10: 0
node_12: 0
node_13: 0
node_14: 0
node_15: 0
node_16: 0
node_17: 0
node_18: 21
node_19: 21
node_20: 2
node_21: 2
node_22: 2
node_24: 17
node_25: 17
node_26: 3
node_27: 5
node_28: 4
node_29: 5

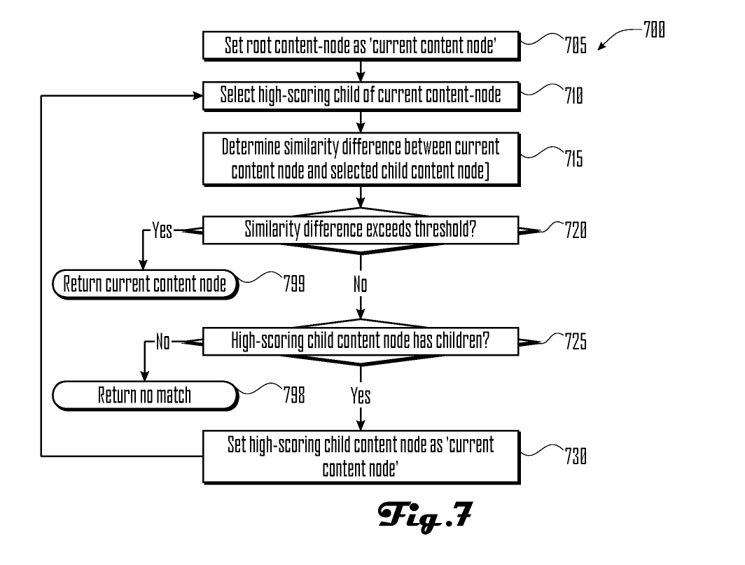

In subroutine block 700, content-node-selection subroutine 600 calls subroutine 700 (see FIG. 7, discussed below) to traverse the given document-object-model to identify a content node (if any) whose children collectively match the given promotion descriptor.

Content-node-selection subroutine 600 ends in ending block 699, returning the content node identified in subroutine block 700 (if any) to the caller.

FIG. 7 illustrates a DOM-traverse subroutine 700 for traversing a given document-object-model to identify a content node (if any) whose children collectively match several given token sub-patterns derived from a given promotion descriptor, such as may be performed by a promotion-monitoring server 900 in accordance with one embodiment.

Content nodes of the given document-object-model have been given similarity scores in a manner similar to that described in content-node-selection subroutine 600 (see FIG. 6, discussed above).

DOM-traverse subroutine 700 begins in block 705 by identifying a root content node of the given document-object-model and setting it as the content node currently being processed.

In block 710, DOM-traverse subroutine 700 selects a high-scoring child of the current content-node. In many embodiments, DOM-traverse subroutine 700 selects the highest-scoring child.

In block 715, DOM-traverse subroutine 700 determines a similarity difference between the current content node and the child content node] selected in block 710.

For example, considering the document-object-model shown in Appendix B, when processing “node_3” (which has a similarity score of 21), DOM-traverse subroutine 700 may select “node_18” as a high-scoring child. The child (“node_18”) has a similarity score of 21, so in one embodiment, DOM-traverse subroutine 700 may determine a similarity difference of 0%, indicating that the high-scoring child content node has a similarity score that is the same as that of its parent.

Similarly, when processing “node_19” (which has a similarity score of 21), DOM-traverse subroutine 700 may select “node_24” as a high-scoring child. The child (“node_24”) has a similarity score of 17, so in one embodiment, DOM-traverse subroutine 700 may deter mine a similarity difference of 19%, indicating that the high-scoring child content node has a similarity score that is 19% below that of its parent.

In the examples discussed above, the similarity difference between a parent and its high-scoring child was described as a percentage computed as a function of 100*(1-child.score/parent.score). In other embodiments, a similarly-functioning similarity difference may be computed according to various other schemes, such as an absolute difference (e.g., child.score-parent.score or parent.score-child.score), an alternate proportion (e.g., parent.score/child.score), or other suitable alternate scheme. In such cases, the predetermined threshold value discussed below would be set accordingly.

In decision block 720, DOM-traverse subroutine 700 determines whether a similarity difference exceeds a predetermined threshold. In the examples discussed above, the predetermined threshold may be set at a value of 15%. In other words, in decision block 720, DOM-traverse subroutine 700 determines whether the high-scoring child selected in block 710 has a similarity score that is at least 15% below that of the current content node. If so, then DOM-traverse subroutine 700 determines that the current content node's children collectively match the several given token sub-patterns, and DOM-traverse subroutine 700 proceeds to ending block 799. Otherwise, DOM-traverse subroutine 700 determines to continue traversing the given document-object-model and proceeds to decision block 725.

In ending block 799, DOM-traverse subroutine 700 ends, returning the current content node, whose children have been determined to collectively match the several given token sub-patterns.

Appendix C (below) illustrates renderable data corresponding to that shown in Appendix A, but with similarity-score and other related attributes assigned to various content nodes. Each content node has a “score” attribute whose value represents a similarity score between the contents of that content node and the given promotion descriptor, as assigned in iterations of block 635 (see FIG. 6, discussed above). The high-scoring child that was selected in iterations of block 710 is indicated in the “top_child” attribute, and the similarity difference determined in decision block 720 is indicated in the “delta” attribute. Using a predetermined threshold of 15%, “node_19” was selected and returned as the content node whose children have been determined to collectively match the several given token sub-patterns.

If in decision block 720, DOM-traverse subroutine 700 determines that the current content node's similarity score differs from its high-scoring child by less than the predetermined threshold, then in decision block 725, DOM-traverse subroutine 700 determines whether the high-scoring child content node has one or more children. If so, then DOM-traverse subroutine 700 proceeds to block 730; otherwise, DOM-traverse subroutine 700 proceeds to ending block 798.

In ending block 798, DOM-traverse subroutine 700 ends, returning no content node whose children collectively match the several given token sub-patterns.

In block 730, DOM-traverse subroutine 700 sets the high-scoring child content node as the ‘current content node’ and iterates back to block 710 to continue traversing the document-object-model.

FIG. 8 illustrates an exemplary content page user-interface 800 showing a simplified browser-rendering of the exemplary renderable data shown in Appendices A-C and discussed herein.

Informational statement 805 represents rendered page content that is not associated with any particular promotion.

Example promotion 810 represents a collection of rendered page contents that corresponds to one of several promotions displayed in content page user-interface 800. Promoted product string 815 identifies a particular product promoted on a section of the rendered page. Image 820 represents an image or other non-textual media corresponding to a promoted product. Promotion text 825 represents promotional content associated with a particular promotion.

Example promotion 830 represents a collection of rendered page contents that corresponds to one of several promotions displayed in content page user-interface 800. Promoted product string 835 identifies a particular product promoted on a section of the rendered page. Image 840 represents an image or other non-textual media corresponding to a promoted product. Promotion text 845 represents promotional content associated with a particular promotion.

FIG. 9 illustrates several components of an exemplary promotion-monitoring server in accordance with one embodiment. In various embodiments, promotion-monitoring server 900 may include a desktop PC, server, workstation, mobile phone, laptop, tablet, set-top box, appliance, or other computing device that is capable of performing operations such as those described herein. In some embodiments, promotion-monitoring server 900 may include many more components than those shown in FIG. 9. However, it is not necessary that all of these generally conventional components be shown in order to disclose an illustrative embodiment.

In various embodiments, promotion-monitoring server 900 may comprise one or more physical and/or logical devices that collectively provide the functionalities described herein. In some embodiments, promotion-monitoring server 900 may comprise one or more replicated and/or distributed physical or logical devices.

In some embodiments, promotion-monitoring server 900 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Promotion-monitoring server 900 includes a bus 905 interconnecting several components including a network interface 910, an optional display 915, a central processing unit 920, and a memory 925.

Memory 925 generally comprises a random access memory (“RAM”) and permanent non-transitory mass storage device, such as a hard disk drive or solid-state drive. Memory 925 stores program code for a monitoring routine 400 for monitoring a page for compliance with a promotion regulation (see FIG. 4, discussed above). In addition, the memory 925 also stores an operating system 935.

These and other software components may be loaded into memory 925 of promotion-monitoring server 900 using a drive mechanism (not shown) associated with a non-transitory computer-readable medium 930, such as a floppy disc, tape, DVD/CD-ROM drive, memory card, or the like.

Memory 925 also includes promotion-compliance database 940. In some embodiments, promotion-monitoring server 900 may communicate with promotion-compliance database 940 via network interface 910, a storage area network (“SAN”), a high-speed serial bus, and/or via the other suitable communication technology.

In some embodiments, promotion-compliance database 940 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

Following this description are Appendices A-C, which provide further information related to the subject matter disclosed herein.

More specifically, Appendix A illustrates a simplified set of exemplary renderable data.

Appendix B illustrates a simplified exemplary document-object-model.

To facilitate human comprehension, this and other example data objects depicted herein are presented according to version 1.2 of the YAML “human friendly data serialization standard”, specified at http://www.yaml.org/spec/1.2/spec.html. In practice, data objects may be represented internally by any suitable data structure, not necessarily the exact data structure used herein for explanatory purposes.

Appendix C illustrates simplified exemplary renderable data whose content nodes have been assigned SimilarityScores as described above.

```
APPENDIX A
<div id=“node_1”>
  <section id=“node_2”>
    <div id=“node_3”>
      <div id=“node_4”>
        <p id=“node_5”>
          Fair credit consumers are on the fence with most credit card
          issuers. Approvals tend to be based on your credit score and
          other factors such as income and credit card debt.
        </p>
        </div>
      <div id=“node_6”>
        <div id=“node_7”>
          <h4 id=“node_8”>
            Capital Three® Classic Unobtainium Credit Card
          </h4>
          <div id=“node_9”>
            <div id=“node_10”>
              <img src=“./cccapitalthree681_small.png” width=“125”
              height=“78” id=“node_11”>
              </div>
            </div>
          <div id=“node_12”>
            <ul id=“node_13”>
              <li id=“node_14”>
                0% intro APR on purchases until January 2015
              </li>
              <li id=“node_15”>
                Get access to a higher credit line after making your
                first 5 monthly payments on time
              </li>
              <li id=“node_16”>
                Fraud coverage if your card is lost or stolen
              </li>
              <li id=“node_17”>
                Use online banking to access your account - even from
                your smartphone with our mobile app
              </li>
              </ul>
            </div>
          </div>
        </div>
      <div id=“node_18”>
        <div id=“node_19”>
          <h4>
            VISA® Unobtainium from Credit Three Bank®
          </h4>
          <div>
            <div>
              <img src=“./cccreditthreebank01_small.png” width=
“125” height=“78”>
              </div>
            </div>
          <div>
            <ul>
              <li>
                1% back on all gas purchases
              </li>
              <li>
                No limit to the gas rewards you can earn
              </li>
              <li>
                Rewards post to your account automatically each
                month
              </li>
              <li>
                Get pre-qualified without affecting your credit score
              </li>
              </ul>
            </div>
          </div>
        </div>
      </div>
    </section>
  </div>
```

```
APPENDIX B
- id: node_0
  type: tag
  name: body
  children:
    - node_1
- id: node_1
  type: tag
  name: div
  children:
    - node_2
- id: node_2
  type: tag
  name: section
  children:
    - node_3
- id: node_3
  type: tag
  name: div
  children:
    - node_4
    - node_6
    - node_18
- id: node_4
  type: tag
  name: div
  children:
    - node_5
- id: node_5
  type: tag
  name: p
  text: Fair credit consumers are on the fence with most credit card issuers.
Approvals tend to be based on your credit score and other factors such as
income and credit card debt.
- id: node_6
  type: tag
  name: div
  children:
    - node_7
- id: node_7
  type: tag
  name: div
  children:
    - node_8
    - node_9
    - node_12
- id: node_8
  type: tag
  name: h4
  text: Capital Three® Classic Unobtainium Credit Card
- id: node_9
  type: tag
  name: div
  children:
    - node_10
- id: node_10
  type: tag
  name: div
  children:
    - node_11
- id: node_11
  type: tag
  name: img
  attribs:
    src:./cccapitalthree681_small.png
    width: “125”
    height: “78”
- id: node_12
  type: tag
  name: div
  children:
    - node_13
- id: node_13
  type: tag
  name: ul
  children:
    - node_14
    - node_15
    - node_16
    - node_17
- id: node_14
  type: tag
  name: li
  text: “0% intro APR on purchases until January 2015”
- id: node_15
  type: tag
  name: li
  text: “Get access to a higher credit line after making your first 5 monthly
payments on time ”
- id: node_16
  type: tag
  name: li
  text: “Fraud coverage if your card is lost or stolen ”
- id: node_17
  type: tag
  name: li
  text: “Use online banking to access your account - even from your
smartphone with our mobile app”
- id: node_18
  type: tag
  name: div
  children:
    - node_19
- id: node_19
  type: tag
  name: div
  children:
    - node_20
    - node_21
    - node_24
- id: node_20
  type: tag
  name: h4
  text: VISA® Unobtainium from Credit Three Bank®
- id: node_21
  type: tag
  name: div
  children:
    - node_22
- id: node_22
  type: tag
  name: div
  children:
    - node_23
- id: node_23
  type: tag
  name: img
  attribs:
    src:./cccreditthreebank01_small.png
    width: “125”
    height: “78”
- id: node_24
  type: tag
  name: div
  children:
    - node_25
- id: node_25
  type: tag
  name: ul
  children:
    - node_26
    - node_27
    - node_28
    - node_29
- id: node_26
  type: tag
  name: li
  text: “1% back on all gas purchases”
- id: node_27
  type: tag
  name: li
  text: No limit to the gas rewards you can earn
- id: node_28
  type: tag
  name: li
  text: Rewards post to your account automatically each month
- id: node_29
  type: tag
  name: li
  text: “Get pre-qualified without affecting your credit score”
```

```
APPENDIX C
<div id=“node_1” score=“21” top_child=“node_2” delta=“0.00”>
  <section id=“node_2” score=“21” top_child=“node_3” delta=“0.00”>
    <div id=“node_3” score=“21” top_child=“node_18” delta=“0.00”>
      <div id=“node_4” score=“0”>
        <p id=“node_5” score=“0”>
          Fair credit consumers are on the fence with most credit card
          issuers. Approvals tend to be based on your credit score and
          other factors such as income and credit card debt.
        </p>
        </div>
      <div id=“node_6” score=“0”>
        <div id=“node_7” score=“0”>
          <h4 id=“node_8” score=“0”>
            Capital Three® Classic Unobtainium Credit Card
          </h4>
          <div id=“node_9” score=“0”>
            <div id=“node_10” score=“0”>
              <img src=“./cccapitalthree681_small.png” width=“125” height=“78”
              id=“node_11”>
              </div>
            </div>
          <div id=“node_12” score=“0”>
            <ul id=“node_13” score=“0”>
              <li id=“node_14” score=“0”>
                0% intro APR on purchases until January 2015
              </li>
              <li id=“node_15” score=“0”>
                Get access to a higher credit line after making your first
                5 monthly payments on time
              </li>
              <li id=“node_16” score=“0”>
                Fraud coverage if your card is lost or stolen
              </li>
              <li id=“node_17” score=“0”>
                Use online banking to access your account - even from
                your smartphone with our mobile app
              </li>
              </ul>
            </div>
          </div>
        </div>
      <div id=“node_18” score=“21” top_child=“node_19” delta=“0.00”>
        <div id=“node_19” score=“21” top_child=“node_24” delta=“0.19”
        fingerprint_match=“true”>
          <h4>
            VISA® Unobtainium from Credit Three Bank®
          </h4>
          <div>
            <div>
              <img src=“./cccreditthreebank01_small.png” width=“125”
height=“78”>
              </div>
            </div>
          <div>
            <ul>
              <li>
                1% back on all gas purchases
              </li>
              <li>
                No limit to the gas rewards you can earn
              </li>
              <li>
                Rewards post to your account automatically each month
              </li>
              <li>
                Get pre-qualified without affecting your credit score
              </li>
              </ul>
            </div>
          </div>
        </div>
      </div>
    </section>
  </div>
```

1. A computer-implemented method for monitoring a page for compliance with a promotion regulation, the method comprising:
obtaining, by the computer, a promotion descriptor comprising a sequence of tokens corresponding to particular promotional content;
identifying, by the computer, a content page comprising renderable data including said particular promotional content among a plurality of other displayed promotions;
generating, by the computer, a document-object-model corresponding to said renderable data, said document-object-model comprising a plurality of hierarchical content nodes;
selecting, by the computer based at least in part on said sequence of tokens, a selected content node of said plurality of hierarchical content nodes, said selected content node containing a plurality of child content nodes that collectively match said promotion descriptor and therefore correspond to said particular promotional content as distinguished from said plurality of other displayed promotions;
storing, by the computer, a record associating said selected content node with said promotion descriptor; and
providing, by the computer for display to a compliance monitor, said selected content node and a compliance-status control for assigning a compliance status to said selected content node with respect to said particular promotional content and the promotion regulation.

2. The method of claim 1, wherein obtaining said promotion descriptor comprises:
obtaining data describing said particular promotional content;
deriving a plurality of search queries based at least in part on said data describing said particular promotional content;
identifying a search-result content page based at least in part on one or more of said plurality of search queries, said search-result content page displaying a plurality of displayed promotions; and
providing a promotion-identification control for distinguishing said particular promotional content among said plurality of displayed promotions.

3. The method of claim 2, wherein obtaining said promotion descriptor further comprises:
receiving, via said promotion-identification control, an indication that an indicated content node of said search-result content page includes said particular promotional content when rendered;
determining a sequence of tokens corresponding to rendered content associated with said indicated content node; and
determining said promotion descriptor based at least in part on said sequence of tokens.

4. The method of claim 3, wherein determining said sequence of tokens comprises:
determining a sequence of normalized words corresponding to rendered text associated with said indicated content node; and
determining a media identifier identifying a rendered non-textual media element associated with said indicated content node.

5. The method of claim 1, wherein selecting said selected content node comprises determining, based at least in part on said sequence of tokens, a plurality of similarity scores corresponding respectively to said plurality of hierarchical content nodes, each similarity score measuring a similarity between said particular promotional content and rendered contents of one of said plurality of hierarchical content nodes and its child content nodes, if any.

6. The method of claim 5, wherein selecting said selected content node comprises selecting said selected content node as having a plurality of child content nodes, wherein said plurality of child content nodes measure above a high similarity threshold when measured collectively, but wherein each individual content node of said plurality of child content nodes measure below a low threshold when measured individually.

7. The method of claim 1, further comprising receiving, via said compliance-status control, a compliance-status indication indicating whether said selected content node, when rendered, complies with the promotion regulation.

8. The method of claim 7, further comprising subsequently monitoring said content page for changes in compliance status with respect to said particular promotional content and the promotion regulation.

9. A computing apparatus for monitoring a page for compliance with a promotion regulation, the apparatus comprising a processor and a memory storing instructions that, when executed by the processor, configure the apparatus to:
obtain a promotion descriptor comprising a sequence of tokens corresponding to particular promotional content;
identify a content page comprising renderable data including said particular promotional content among a plurality of other displayed promotions;
generate a document-object-model corresponding to said renderable data, said document-object-model comprising a plurality of hierarchical content nodes;
select, based at least in part on said sequence of tokens, a selected content node of said plurality of hierarchical content nodes, said selected content node containing a plurality of child content nodes that collectively match said promotion descriptor and therefore correspond to said particular promotional content as distinguished from said plurality of other displayed promotions;
store a record associating said selected content node with said promotion descriptor; and
provide, for display to a compliance monitor, said selected content node and a compliance-status control for assigning a compliance status to said selected content node with respect to said particular promotional content and the promotion regulation.

10. The apparatus of claim 9, wherein the instructions that configure the apparatus to obtain said promotion descriptor further comprise instructions configuring the apparatus to:
obtain data describing said particular promotional content;
derive a plurality of search queries based at least in part on said data describing said particular promotional content;
identify a search-result content page based at least in part on one or more of said plurality of search queries, said search-result content page displaying a plurality of displayed promotions; and
provide a promotion-identification control for distinguishing said particular promotional content among said plurality of displayed promotions.

11. The apparatus of claim 10, wherein the instructions that configure the apparatus to obtain said promotion descriptor further comprise instructions configuring the apparatus to:
receive, via said promotion-identification control, an indication that an indicated content node of said search-result content page includes said particular promotional content when rendered;
determine a sequence of tokens corresponding to rendered content associated with said indicated content node; and
determine said promotion descriptor based at least in part on said sequence of tokens.

12. The apparatus of claim 11, wherein the instructions that configure the apparatus to determine said sequence of tokens further comprise instructions configuring the apparatus to:
determine a sequence of normalized words corresponding to rendered text associated with said indicated content node; and
determine a media identifier identifying a rendered non-textual media element associated with said indicated content node.

13. The apparatus of claim 9, wherein the instructions that configure the apparatus to select said selected content node further comprise instructions configuring the apparatus to determine, based at least in part on said sequence of tokens, a plurality of similarity scores corresponding respectively to said plurality of hierarchical content nodes, each similarity score measuring a similarity between said particular promotional content and rendered contents of one of said plurality of hierarchical content nodes and its child content nodes, if any.

14. The apparatus of claim 13, wherein the instructions that configure the apparatus to select said selected content node further comprise instructions configuring the apparatus to select said selected content node as having a plurality of child content nodes, wherein said plurality of child content nodes measure above a high similarity threshold when measured collectively, but wherein each individual content node of said plurality of child content nodes measure below a low threshold when measured individually.

15. A non-transitory computer-readable storage medium having stored thereon instructions including instructions that, when executed by a processor, configure the processor to:
obtain a promotion descriptor comprising a sequence of tokens corresponding to particular promotional content;
identify a content page comprising renderable data including said particular promotional content among a plurality of other displayed promotions;
generate a document-object-model corresponding to said renderable data, said document-object-model comprising a plurality of hierarchical content nodes;
select, based at least in part on said sequence of tokens, a selected content node of said plurality of hierarchical content nodes, said selected content node containing a plurality of child content nodes that collectively match said promotion descriptor and therefore correspond to said particular promotional content as distinguished from said plurality of other displayed promotions;
store a record associating said selected content node with said promotion descriptor; and
provide, for display to a compliance monitor, said selected content node and a compliance-status control for assigning a compliance status to said selected content node with respect to said particular promotional content and a promotion regulation.

16. The non-transitory computer-readable storage medium of claim 15, wherein the instructions that configure the processor to obtain said promotion descriptor further comprise instructions configuring the processor to:
obtain data describing said particular promotional content;
derive a plurality of search queries based at least in part on said data describing said particular promotional content;
identify a search-result content page based at least in part on one or more of said plurality of search queries, said search-result content page displaying a plurality of displayed promotions; and
provide a promotion-identification control for distinguishing said particular promotional content among said plurality of displayed promotions.

17. The non-transitory computer-readable storage medium of claim 16, wherein the instructions that configure the processor to obtain said promotion descriptor further comprise instructions configuring the processor to:
receive, via said promotion-identification control, an indication that an indicated content node of said search-result content page includes said particular promotional content when rendered;
determine a sequence of tokens corresponding to rendered content associated with said indicated content node; and
determine said promotion descriptor based at least in part on said sequence of tokens.

18. The non-transitory computer-readable storage medium of claim 17, wherein the instructions that configure the processor to determine said sequence of tokens further comprise instructions configuring the processor to:
determine a sequence of normalized words corresponding to rendered text associated with said indicated content node; and
determine a media identifier identifying a rendered non-textual media element associated with said indicated content node.

19. The non-transitory computer-readable storage medium of claim 15, wherein the instructions that configure the processor to select said selected content node further comprise instructions configuring the processor to determine, based at least in part on said sequence of tokens, a plurality of similarity scores corresponding respectively to said plurality of hierarchical content nodes, each similarity score measuring a similarity between said particular promotional content and rendered contents of one of said plurality of hierarchical content nodes and its child content nodes, if any.

20. The non-transitory computer-readable storage medium of claim 19, wherein the instructions that configure the processor to select said selected content node further comprise instructions configuring the processor to select said selected content node as having a plurality of child content nodes, wherein said plurality of child content nodes measure above a high similarity threshold when measured collectively, but wherein each individual content node of said plurality of child content nodes measure below a low threshold when measured individually.
